(19) United States
(12) Patent Application Publication
(10) Pub. No.: US 2023/0394356 A1
(43) Pub. Date: Dec. 7, 2023

(54) DYNAMIC MODEL SCOPE SELECTION FOR CONNECTED VEHICLES

(71) Applicant: Telefonaktiebolaget LM Ericsson (publ), Stockholm (SE)

(72) Inventors: Lucas CHIZALLI, Tirolo (IT); Fengkai WAN, Bromma (SE); Tony LARSSON, Upplands Väsby (SE)

(21) Appl. No.: 18/033,668

(22) PCT Filed: Nov. 8, 2021
(86) PCT No.: PCT/SE2021/051113

§ 371 Date: Apr. 25, 2023

Related U.S. Application Data
(60) Provisional application No. 63/111,252, filed on Nov. 9, 2020.

(51) Int. Cl. G06N 20/00

(52) U.S. Cl. CPC G06N 20/00

(57) ABSTRACT

A computing device in a network receives, into a machine learning model, a value for a prediction horizon, Tw, that defines a future time interval for generating predicted data corresponding to an element in a model region. Machine learning training data is received that includes data corresponding to previous element activity in the model region, which includes at least one model cluster, and wherein each of the at least one model cluster includes a plurality of adjacent model cells. Using the machine learning model, model cell parameters are generated defining a cell size and a cell geometry. Using the machine learning model, model cluster parameters are generated that include a cluster geometry, a cluster centroid value identifying a center of the model cluster and a cluster radius value defining a quantity of model.

### TECHNICAL FIELD

The present disclosure relates generally to connectivity of wireless communication systems in vehicles, and related methods and apparatuses.

### BACKGROUND

Connected vehicles are automobiles with wireless communication systems that communicate with their environment. They may be proactive, cooperative and well-informed on the go. Connectivity enables a variety of applications, such as in-vehicle information, entertainment (“infotainment”), fleet management and route optimization. Multiple solutions have been provided to Original Equipment Manufacturers (OEMs) of connected cars. Examples of such solutions include Ericsson Device Analytics (EDA) and Connected Vehicle Cloud (CVC). Customers of such technology are worldwide and a connected vehicle cloud platform for vehicle manufacturers may connect over 4.5 million vehicles across 130 countries.

Wireless connection quality can severely influence the functionality of connected vehicles. It is often the case that no single mobile operator can provide sufficient coverage for the entirety of a connected vehicle's trip. Therefore, connections to multiple operators may be needed to achieve reliable and sufficient connectivity.

Device analytics may address this problem by collecting real time connectivity performance data from multiple devices. This data enables real time monitoring and provides insight into how networks and connected devices will likely perform at any given moment in time. In addition, products may be pursued that provide predictive capabilities to identify the best available operators at a given vehicle's future location by tracking its movement and the network quality in its surrounding area.

### SUMMARY

Some embodiments of the present disclosure include methods performed by a computing device in a network. Operations according to such methods may include receiving, into a machine learning model, a value for a prediction horizon, Tw, that defines a future time interval for generating predicted data corresponding to an element in a model region. Operations may include receiving machine learning training data that includes data corresponding to previous element activity in the model region. The model region includes at least one model cluster and each of the at least one model clusters comprises multiple model cells that are adjacent one another. Operations include generating, using the machine learning model, model cell parameter values that define a cell size and/or a cell geometry. Some embodiments provide that the model cell parameters may be configured manually and/or may be generated empirically using a data driven approach. For example, some embodiments provide that cell geometry may be configured manually. Operations may include generating, using the machine learning model, model cluster parameters that include a cluster geometry, a cluster centroid value that identifies a center of the model cluster and a cluster radius value that defines a quantity of model cells from the cluster centroid value to an edge of the model cluster.

Some embodiments herein are directed to a computing device including machine learning dynamic model scope selection. The computing device includes at least one processor and at least one memory connected to the at least one processor. The memory stores program code that is executed by the at least one processor to perform operations including receiving machine learning training data that includes data corresponding to previous element activity in the model region, wherein the model region includes at least one model cluster, and wherein each of the at least one model clusters includes multiple model cells that are adjacent one another. Operations include generating, using the machine learning model, model cell parameter values that define a cell size and/or a cell geometry. Some embodiments provide that the model cell parameters may be configured manually and/or may be generated empirically using a data-driven approach. Operations include generating, using the machine learning model, model cluster parameters that include a cluster geometry, a cluster centroid value that identifies a center of the model cluster and a cluster radius value that defines a quantity of model cells from the cluster centroid value to an edge of the model cluster.

Some embodiments are directed to a computer program including program code to be executed by processing circuitry of a computing device including machine learning dynamic model scope selection for a radio network. In some embodiments, execution of the program code causes the computing device to perform operations including receiving machine learning training data that includes data corresponding to previous element activity in the model region. The model region includes at least one model cluster and each of the at least one model clusters includes multiple model cells that are adjacent one another. Operations include generating, using the machine learning model, model cell parameter values that define a cell size and/or a cell geometry. Some embodiments provide that the model cell parameters may be configured manually and/or may be generated empirically using a data-driven approach. Operations include generating model cluster parameters that include a cluster geometry, a cluster centroid value that identifies a center of the model cluster and a cluster radius value that defines a quantity of model cells from the cluster centroid value to an edge of the model cluster.

Some embodiments disclosed herein are directed to a computer program product including a non-transitory storage medium including program code to be executed by processing circuitry of a computing device that is adapted for machine learning dynamic model scope selection for a radio network. Execution of the program code causes the computing device to perform operations including receiving machine learning training data that includes data corresponding to previous element activity in the model region. The model region includes at least one model cluster and each of the at least one model clusters includes multiple model cells that are adjacent to one another. Operations include generating model cell parameters that define a cell size and/or a cell geometry. Some embodiments provide that the model cell parameters may be configured manually and/or may be generated empirically using a data-driven approach. Operations may include generating model cluster parameters that include a cluster geometry, a cluster centroid value that identifies a center of the model cluster and a cluster radius value that defines a quantity of model cells from the cluster centroid value to an edge of the model cluster. Some embodiments provide that the model cluster parameters may be configured manually and/or may be generated empirically using a data-driven approach.

Advantages over the currently known techniques provide partitioning of target regions into efficient and optimized scopes that are computationally less demanding in a substantially data-driven manner that allows data collection and model training in an isolated fashion for each model scope using a machine learning algorithm.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram that illustrates an overview of overlapping Hexclusters in accordance with some embodiments of the present disclosure;

FIG. 2 is a schematic diagram illustrating a plurality of model cells defined over a geographical area corresponding to an example use case according to some embodiments of the present disclosure;

FIG. 3 is a schematic flow diagram illustrating operations for model scope selection and Hexcluster generation according to some embodiments of the present disclosure;

FIG. 4 is a schematic flow diagram illustrating operations for generating Hexclusters according to some embodiments of the present disclosure;

FIG. 5 is a schematic diagram illustrating performing predictions in areas of overlapping Hexclusters according to some embodiments of the present disclosure;

FIG. 6 schematically illustrates three neighboring Hexclusters with different H3 cell levels according to some embodiments of the present disclosure;

FIG. 7 schematically illustrates a model region with a rectangular bounded region identifying Hexclusters and/or portions of Hexclusters for which predictions are to be made according to some embodiments disclosed herein;

FIGS. 8-15 are flow charts of operations according to various embodiments of the present disclosure; and

FIG. 16 is a block diagram of a computing device in accordance with some embodiments of the present disclosure

FIG. 17 is a block diagram of a radio network in accordance with some embodiments of the present disclosure.

### DETAILED DESCRIPTION

A solution outlined herein may provide an integral part of prediction capabilities of a future EDA product iteration.

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter. The term “network node” is used in a non-limiting manner and, as explained below, can refer without limitation to any type of network node in a radio network including, without limitation, a network node for receiving recommendation(s) in accordance with various embodiments of the present disclosure (also referred to herein as a “site”), such as a base station.

Mobility is a natural property of connected vehicles and brings great convenience to users. However, it also leads to challenges like handover, paging and registration, amongst others. Mobility, if not managed well, can cause degradation in connectivity. Mobility prediction is an efficient way to help maintain adequate connectivity. As such, accurate mobility prediction enables efficient management of network connections.

Accurate prediction of when and where a given vehicle will be is important for connected vehicles. By means of such predictions, a system can take proactive actions such as switching Mobile Network operator (MNO) or pre-caching content with the goal to improve the end-user experience. Many popular Machine Learning (ML) methods like Markov chain, hidden Markov model, and Artificial Neural Networks (ANN) may be used for these types of predictions.

Predicting the location for connected vehicles can be done in many different ways and can be based on different representations of geographic locations. For example, locations can be represented as longitude and latitude pairs, street address, network cell of a particular MNO or some other type of geocoding system, which is disclosed herein.

A geocoding system may encode geographical locations by means of unique identifiers. Such encoding effectively hashes locations and enables faster spatial queries and operations, such as clustering. Examples of geocoding include geohash, S2 Geometry and Uber H3, among others. These systems may divide the planet into different subsets (cells) following very similar approaches: (1) Map projection: Flatten Earth's surface into a plane (i.e. move from 3D to 2D); (2) Split plane into smaller, unique units of a chosen shape (also referred to as grid cells).

One of the major differences between these systems is the shape of grid cells. For example, grids may consist of rectangular shaped cells. In systems like geohash and S2 Geometry, the Earth is divided into hierarchical rectangles. These models are widely adopted in industry. However, due to the nature of rectangles, the distance from a given rectangle cell to its closest neighboring cells can vary. This makes it difficult to efficiently calculate distances. Fortunately, Uber has developed a geocoding system named H3 [5], which primarily uses hexagon shaped cells. Hexagons have the same distance to all their neighbors and therefore simplify the approximation of distances.

Uber is using H3 to analyze various business aspects on a geographical level, such as predicting ride supply and demand for various geographical areas. This may enable dynamic pricing and city-wide decision making.

Some embodiments provided herein may be based on the H3 grid system. However, embodiments may be applied to other systems as well provided that cells' shapes are consistent.

Another important issue when creating predictive models for mobility is the extent of a geographical area a given model covers. It may not be practically feasible to train and operate one global model responsible for forecasting locations anywhere on Earth. This may be due to the large amount of data needed and/or the constraints in model size and inferences speeds. Such a model may become too big to store efficiently and too slow to use in real time.

The geographical area that a given model should cover must be set before such model can be trained. We will refer to this as the model scope in the remainder of the document. Embodiments of this disclosure may focus on how to dynamically set the model scope for predictive models in a connected vehicle scenario.

There are two different approaches for providing predictive services on a global scale. One is to serve a single global market using one model and the other involves splitting the global market into smaller, regional markets with each one being serviced by its own model.

As discussed above, using one model for the entire globe is not scalable since it will be computationally inefficient to store as well as computationally expensive to train and obtain predictions.

Multiple models for different regions may be more reasonable. However, depending on how the Earth is split into smaller regions, this approach may be labor intensive or suboptimal. One option is to manually choose regions of interest, which may be time consuming and error prone. Another option involves partitioning the planet using existing geographical units like postal codes, city or country borders, etc. While this would enable automaticity, compatibility for trips across different model scopes may not be ensured. Such option further suffers from the limitation that some regions do not have enough data to train a model with sufficient accuracy.

Solutions corresponding to problems of existing solutions are discussed herein.

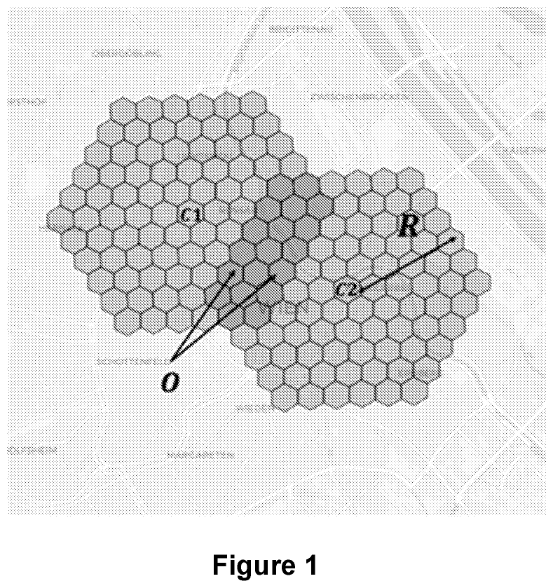

Some embodiments provide a special model scope that may be referred to as a Hexcluster, which may include a regular hexagon formed by a group of H3 cells. For example, reference is now made to FIG. 1, which is a schematic diagram that illustrates an overview of overlapping Hexclusters in accordance with some embodiments herein. As illustrated, each of the Hexclusters may have one centroid H3 cell (C1 and C2). The radius (R) of one Hexcluster may be defined as the number of H3 cells from the centroid H3 cell to the Hexclusters boundary.

While embodiments herein may be described in the context of a hex-based geometry, the disclosure is not so limited. For example, it will be understood that the example terms such as H3 cell and Hexcluster may include geometries other than hexagonal such as, for example, rectangles, quadrilaterals, ellipses, ovals, circles, triangles, pentagons and/or octagons, among others. Thus, reference to and/or usage of the term H3 cell may be applied to and/or used in the context of a spatially defined cell having any one or more of the geometries provided above. Similarly, reference to and/or usage of the term Hexcluster may be applied to and/or used in the context of a cluster of spatially defined cells.

Neighboring Hexcluster overlaps (O) may be introduced to assist in making predictions for trips that cross model scopes. A final prediction for such trips within an overlapping area may be a weighted combination of all involved models.

A given target geographical region may be partitioned into multiple, overlapping Hexclusters. Given an initial location within this target region and chosen Hexcluster parameters, such as radius and overlap, all Hexclusters can be generated recursively. This process may be fully automated and can be optimized based on the data available for a given target region.

For each Hexcluster, an ML model may be trained independently based on that cluster's data. In addition, model updates and hyperparameter tuning (H3 cell level, prediction horizon) can be automatically triggered based on data collected and model performance monitoring.

The overlapping Hexclusters illustrated in FIG. 1 include centroid H3 cells (C1, C2) for the two Hexclusters. They have radius R, which is the number of H3 cells from the centroid to the Hexcluster's boundary. The darker shaded cells refer to the area of overlap and its extent is defined by O, which is the number of H3 cells pertaining to both neighboring Hexclusters.

In some embodiments, approaches disclosed herein provide that a target region is partitioned into efficient and/or optimized model scopes (Hexclusters) using fully data driven and automatic operations. In this manner, less human interaction may be needed to manage a global service. Some embodiments provide that data collection and model training/updating are performed in an isolated fashion relative to each Hexcluster. Some embodiments may not be specific to an ML algorithm. In some embodiments, ML models trained for Hexclusters can be replaced without influencing other data flow characteristics.

As discussed above, mobility prediction may deal with various types of predictions for connected vehicles. Some embodiments provide that predictions may be about where vehicles will be in the future and what connectivity type and quality that vehicles can expect at those future locations.

In some embodiments, predictions may typically be performed by ML models that need to be trained based on data collected including, for example, vehicles themselves and/or the networks that vehicles connect to. Models for location prediction may use, for example, historical location data of vehicles. These models can explicitly or implicitly learn road topologies, meaning that models for this purpose may be typically trained for a specific geographical area.

As provided above, it may not be practically feasible to train one global model that would handle all locations in the world. The geographical area that one model should cover needs to be determined before the model can be trained. This determination of the geographical area may be referred to as the model scope. For example, the model scope can be one model for a city, such as the city of Stockholm. In some embodiments, this scope may be set manually by domain experts, product owners and/or data scientists, among others.

Operations disclosed herein may address challenges corresponding to dynamically and automatically setting and optimizing the model scope for a large geographical area such as a country, a continent or even an entire planet. This includes aspects such as: setting the size for each model scope based on requirements from the application, identifying the number of models needed to cover a geographic area, e.g. a country such as Sweden, and dealing with transitions between models, when the vehicle drives between areas served by different models.

An example use-case corresponding to approaches disclosed herein includes location prediction for vehicles. Although discussed in the context of location prediction for vehicles, embodiments herein are not so limited as such embodiments may be applicable to any model that is bound to a geographical area and where interactions between geographical areas must be considered.

This example may focus on predicting the H3 cell that a given vehicle will arrive in given a specific prediction horizon. Such a prediction horizon is denoted as Tw. For instance, Tw=60 means that the model aims at predicting which H3 cell a vehicle will be in after 60 seconds.

Some embodiments provide that the model takes the input of the H3 cell of a vehicle's current location and the H3 cell of a vehicle's previous location, Tw seconds before current time stamp. This input may be used to predict future H3 cell(s) that a vehicle is likely to be in after Tw seconds. The model itself can for instance be a Markov chain model or an Artificial Neural Network. For the purpose of this document, a second order Markov chain model is used as an example.

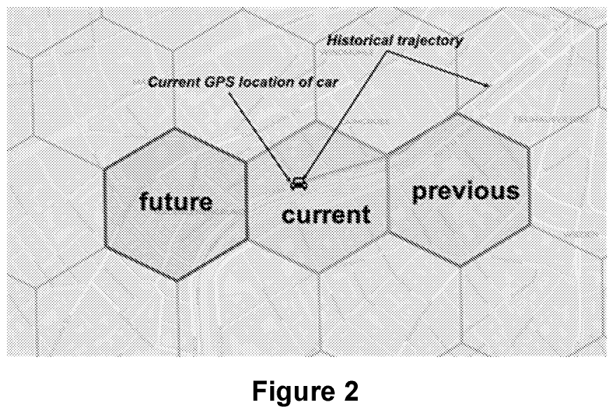

Reference is now made to FIG. 2, which is a schematic diagram illustrating a plurality of H3 cells defined over a geographical area corresponding to an example use case according to some embodiments. In FIG. 2, the historical H3 cell is denoted as previous, the; current H3 cell is denoted as current; and the predicted H3 cell is denoted as future. Although the present example uses a single H3 cell, embodiments herein contemplate that multiple previous H3 cells may be used. In the use case of location prediction of FIG. 2, one transition sequence consists of transitions from previous H3 cell to the current H3 cell and from the current H3 cell to the future H3 cell. Transition sequences can then be used to train an ML model, which may ultimately be used for performing prediction. For example, the ML model may be used for identifying the most likely future H3 cell for a given vehicle.

For example, in FIG. 2, a car is traveling along a road. According to its historical trajectory we can see that it is moving from right to left and it has traveled from the previous H3 cell to the current H3 cell after Tw seconds. Based on the transition from the previous H3 cell to the current H3 cell, a second order Markov chain model as disclosed herein can predict that this car will arrive at the highlighted future H3 cell after Tw.

Definitions and Concepts

This section outlines some of the key concepts disclosed herein:

Model scope: Geographical area covered by a Hexcluster model. For instance, there are two model scopes in FIG. 1 covered by Hexclusters C1 and C2.

H3 cell: Grid cell of a geocoding system in the shape of a hexagon. The H3 grid system has 16 different levels of resolution ranging from zero to fifteen. The larger the level, the smaller the cell area.

Hexcluster: Regular hexagon formed by a group of H3 cells. See definition of model scope.

Hexcluster centroid: H3 cell at the center of a Hexcluster. For example, in FIG. 1 the H3 cell marked with C1 is the centroid of Hexcluster C1. Such a centroid acts as the unique identifier of a Hexcluster.

Hexcluster radius: Number of H3 cells from a Hexcluster's centroid to its outer boundary. As shown in FIG. 1, R is the radius of Hexcluster C2. Although some embodiments use the number of H3 cells to determine the radius of the Hexcluster, the disclosure is not so limited as other ways of determining the radius may be used.

Hexcluster overlap: The number of overlapping H3 cells among neighboring Hexclusters. As shown in FIG. 1, O is the darker shaded area between the two Hexclusters.

Model region: Large geographical area of interest that should be covered by multiple Hexclusters. For instance, it could be a city, country, continent or even the entire planet.

Although only discussed in the context of location prediction for vehicles, embodiments herein are applicable to other use cases and/or applications including predicting the future H3 cells that vehicles will be in as described in herein.

Automatic generation of Hexclusters is provided herein. Appropriate configuration of parameters such as initial H3 level, prediction horizon Tw, Hexcluster radius, Hexcluster overlap may be useful. Parameter configuration may be data driven and automated to a certain extent. Once parameters are configured, Hexclusters can be generated recursively until the entire model region is covered by individual model scopes. Models like second order Markov chain can be trained in each of the Hexclusters to get transition matrices. In case transition matrices are too large and thus may reduce computational efficiency, Hexclusters can be generated using a smaller radius. Lastly, model updates for each of the Hexclusters are data and performance driven. As new data is collected, the model's performance is tracked and re-training or updates of parameter configurations are scheduled should performance drop or other conditions are met.

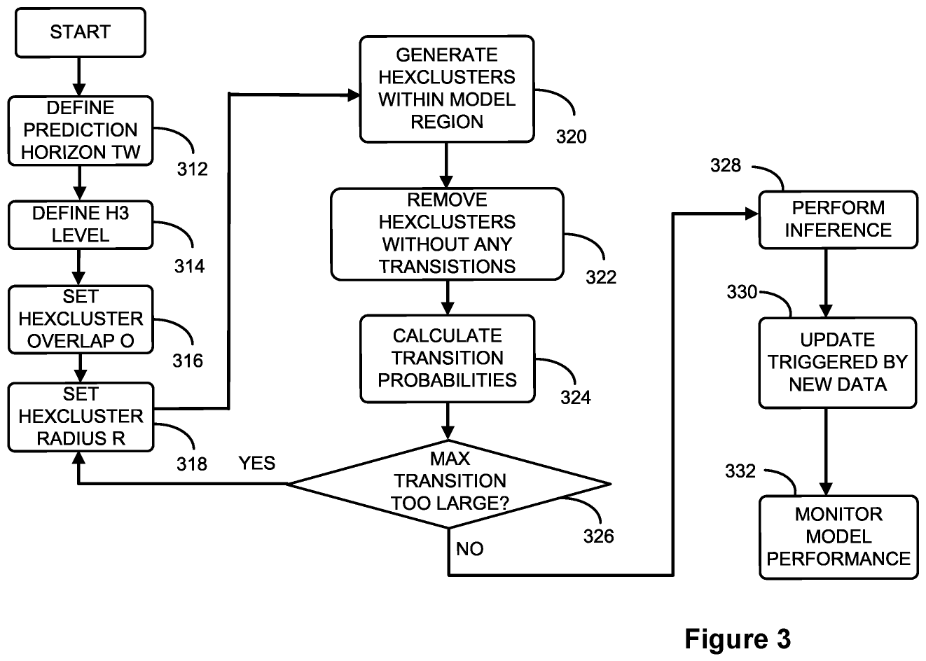

Reference is now made to FIG. 3, which is a schematic flow diagram illustrating operations for model scope selection and Hexcluster generation according to some embodiments. Operations include defining a prediction horizon (block 312). In some embodiments, the prediction horizon, which may be represented as Tw, may define how far into the future a devised model provides predictions. In the mobility example, the prediction horizon Tw should be long enough so that vehicles cross into other H3 cells. For example, the prediction horizon Tw should be set for the prediction to be useful and also to allow a connected vehicle to take necessary proactive measures to ensure connectivity. For example, the prediction horizon Tw should not be too long since the amount of uncertainty increases as the prediction extends further into the future (e.g. weather forecasts) and thus prediction accuracies drop. Generally, the configuration of prediction horizon should be adapted according to applicable system requirements while keeping accuracy implications in mind.

In some embodiments, the prediction horizon Tw may be a value that is provided, at least initially, as an input into the system. As provided later, feedback corresponding to performance of the system may be used to refine and/or optimize the value of the prediction horizon Tw.

After the prediction horizon is defined, an initial H3 cell is defined (block 314). In some embodiments, the H3 cell level determines the location prediction's granularity. For example, a higher H3 cell level may be associated with smaller H3 cells than a lower H3 cell level. A higher H3 cell level may enable more precise location prediction. However, the higher H3 cell level may require more data and may increase memory requirements exponentially. Therefore, setting an adequate initial H3 cell level may be critical to system performance.

Some embodiments provide that once more data is available for a certain Hexcluster or model region, a higher H3 cell level may be chosen. This update can be triggered to occur automatically.

Both H3 cell level and prediction horizon Tw may be important parameters. Some embodiments provide that the H3 cell level and/or the prediction horizon Tw may be determined manually and/or through data driven approaches, the examples of which are discussed herein.

Operations include setting the Hexcluster overlap, which may be represented as O (block 316). The Hexcluster overlap may be used when determining location prediction when vehicles are traveling from one Hexcluster to another. For example, if a vehicle is in an overlapping area, the prediction will be a weighted average across all relevant models. As used herein, the Hexcluster overlap may be estimated based on the maximum number of H3 cells (max_{c}) a vehicle can visit according to a defined maximum speed within the prediction horizon Tw. Empirically, overlap O should be configured with the rule O≥2*max_{c}, where max_{c} is calculated according to:
max_{c}=((maxₛ*Tw)/d_{c})+1;
   with maxₛ being the maximum possible speed of vehicles and being the diameter of H3 cells.

Operations may include setting the Hexcluster radius, which may be represented as R (block 318). In some embodiments, a second order Markov chain model may be used and may generate a transition matrix containing all possible transition probabilities across cells once the model is trained. The more H3 cells in a Hexcluster, the larger the transition matrix and thus the more computational resources are needed to store the model and to perform inferences.

In some embodiments, the Hexcluster radius R defines the total number of H3 cells within a Hexcluster. Thus, the radius should be relatively small in order to ensure computational efficiency. However, a larger radius can reduce cross model predictions and the number of Hexclusters needed to cover a given model region. The selection process of Hexcluster radius R may be empirical and may depend significantly on model region, geographical distribution of data, available computing resource etc. According to some embodiments, a Hexcluster radius R may be much larger than Hexcluster overlap O such that R>>O. In some embodiments, the Hexcluster radius R can be adapted automatically at a later stage if transition matrices turn out to be too large.

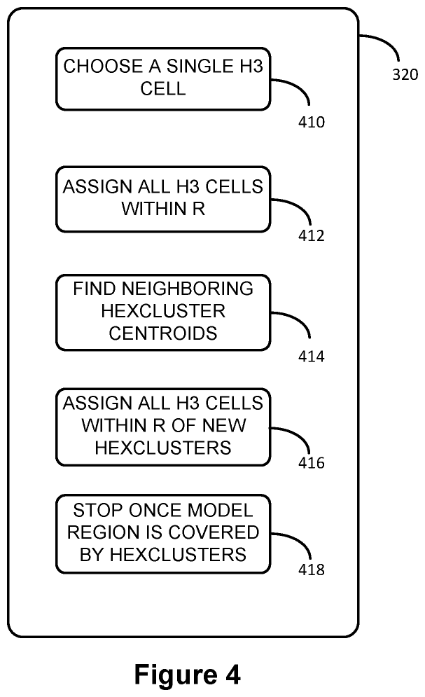

Operations may include generating Hexclusters within a model region (block 320). In some embodiments, having selected all the parameters detailed above, Hexclusters can be generated recursively. Brief reference is now made to FIG. 4, which is a schematic flow diagram illustrating operations for generating Hexclusters according to some embodiments. Operations for generating Hexclusters may include choosing a single H3 cell within model region to act as the centroid of the first Hexcluster (block 410). In some embodiments, the single H3 cell may be selected randomly and/or defined as an input provided to the system. Some embodiments provide that choosing the single H3 cell may be based on random and/or may be performed in a data-driven fashion.

Operations include assigning all H3 cells that are within R distance of this cell to the same Hexcluster (block 412). If the entire model region is not yet fully covered by Hexclusters, find all neighboring Hexcluster centroids using R and 0 (block 414). Operations include assigning all H3 cells within R distance to these new Hexcluster centroids to the respective new Hexcluster (block 416). Once the entire model region is covered by Hexclusters, the operations for generating Hexclusters within the model region may be stopped (block 418).

Referring back to FIG. 3, operations may include removing Hexclusters that do not have any transitions (block 322). For example, during the training of the mobility prediction model, data is collected during actual trips of connected vehicles. The collected data may provide that certain Hexclusters do not contain trip data. As such, no models were trained corresponding to those Hexclusters. As such, the Hexclusters may be removed.

Operations may include calculating transition probabilities (block 324). For Hexclusters with enough data, second order Markov chain models are trained independently to obtain transition matrices.

Operations may include determining if the maximum number of transitions for some Hexclusters is too large (block 326). If the maximum numbers of transitions for some Hexclusters are too large, Hexclusters radius R may be reduced to improve computational efficiency. In such embodiments, the Hexcluster radius R may be set (block 318) to a new value. Some embodiments provide that after training every Hexcluster will have a transition matrix that can be used to perform an inference (block 328). For example, if the maximum number of transitions is not too large, then after training is performed the operations may include performing an inference that identifies the most likely future H3 cell. In some embodiments, the inference may include a confidence value P that is associated with the predicted H3 cell.

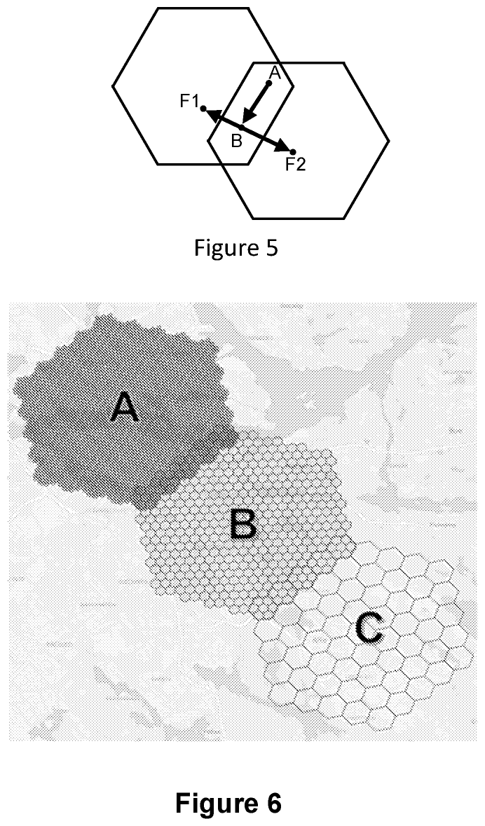

Some embodiments provide that, if previous and current H3 cells are in an overlapping area of neighboring Hexclusters, the prediction may include a weighted average of all relevant Hexcluster models' predictions. In some embodiments, a maximum argument expression may be used to select the most probable prediction. For example, brief reference is now made to FIG. 5, which is a schematic diagram illustrating performing predictions in areas of overlapping Hexclusters according to some embodiments. As illustrated, FIG. 5 outlines an example of this weighted average. Assuming that a vehicle's current H3 cell is B, and its previous H3 cell is A, the transition from A to B may exist in both Hexclusters (hexagon shapes). For the left Hexcluster model, the most likely next cell given A->B is F1 with confidence P=97% and the sequence of A->B->F1 has occurred a total of 10 times in the past. The number of times the sequence has occurred may be referred to as the absolute frequency. For the right Hexcluster model, the most likely next cell given A->B is F2 with P=87% and the sequence of A->B->F2 has occurred a total of 12 times in the past. In this case, the most likely future H3 cell will be the one with maximum product of confidence and occurrence as outlined in following formula:

Argmax((0.97*10)/(10+12),(0.87*12)/(10+12))=argmax(44.1,47.5)=>F2

Referring back to FIG. 3, new data may be received, and an update may be trigger by the new data (block 330). For example, new data may be collected in real-time and on a continuous basis. Given specific conditions, such as the total amount of new data or increase in density being above a selected threshold, a given Hexcluster and its model can be updated.

When models are updated, some embodiments may include a change among different H3 cell levels for some Hexclusters. For instance, if one Hexcluster has collected enough data and the data density is considerably high, higher H3 levels can be used to allow for more precise location predictions.

Operations may include monitoring model performance (block 332). For example, the continuous tracking of model performance may provide advantageous functionality. For example, in the context of location prediction, by comparing the location prediction with the actual future location after Tw, it may be possible to estimate a model's accuracy. Some embodiments provide that if performance metrics fall below a certain threshold, a result that may be referred to as model drift may occur. Such instances may be used to trigger a model update or trigger system administrators to review the model and data pipeline.

In some embodiments, generating Hexclusters may be a recursive process starting from a single location within a chosen model region. Such process may be time consuming if the chosen model region is large (such as continent or entire planet).

In some embodiments, efficiency may be gained by limiting model regions to relevant landmasses: i.e. model region covers everything on Earth excluding large bodies of waters and uninhabited regions, such as Antarctica.

Additionally, for isolated landmasses like Australia, Hexcluster generation can be done independently and in parallel from other landmasses like Afro-Eurasia to improve efficiency.

Such embodiments may be applicable for smaller model regions as well. Shape files of geographic regions can be obtained from open source provider such as Open Street Map (OSM) and user-defined shape files may be created directly. In some embodiments, one model region can be partitioned into smaller regions to make the generation of Hexclusters happen in parallel. Administrators can choose among the different embodiments to improve efficiency.

In some embodiments, parameter optimization of Hexclusters may be data driven. For example, before optimizing parameters for individual Hexclusters, global parameters such as the baseline H3 cell level as well as the H3 starting cell for Hexcluster generation can be optimized using insights gained from data.

For example, the minimum amount of data per H3 cell for various H3 cell levels can be used to set the smallest supportable H3 cell level for a given model region. Further, based on the geographical distribution of measurements, a H3 cell within the area with most observations can be chosen as a starting point for the recursive Hexcluster generation. Such approaches may enable more efficient and higher performing location prediction models.

In some embodiments, handling transitions may be performed robustly for transitions among neighboring Hexclusters with different H3 cell levels. For example, brief reference is now made to FIG. 6, which schematically illustrates three neighboring Hexclusters with different H3 cell levels according to some embodiments disclosed herein. For example, Hexcluster A covers the busy central district of a major city, which has most data and the highest data density. In such areas, models operating on higher H3 cell levels are possible to provide more precise location predictions. The other two Hexclusters B and C contain less populated areas and thus have less data and lower data density. The mechanism of handling prediction in overlapping area may be performed as discussed above.

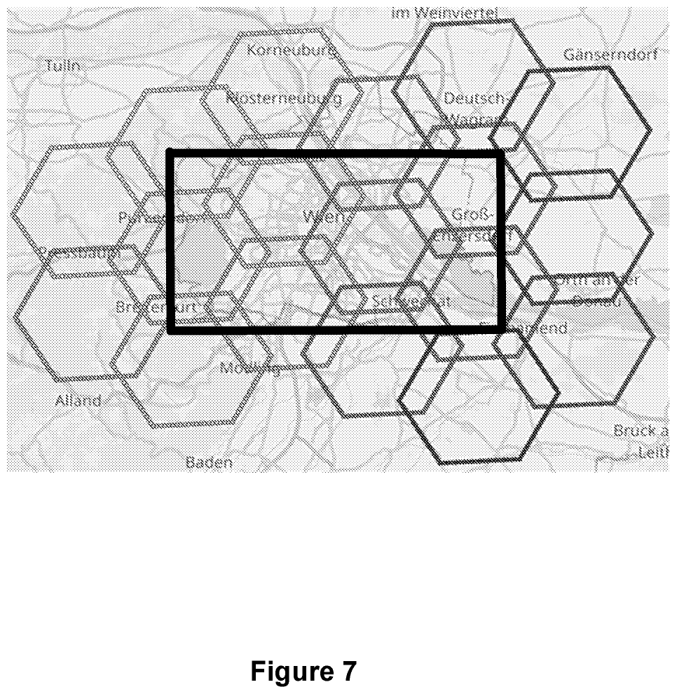

Some embodiments provide that model region details may be provided based on system operators defining the geographic regions for which location prediction should be made available. This can be done by providing complex shapefiles or simple geometric shapes, such as rectangles that define the maximum and minimum latitude as well as longitude values. For example, brief reference is now made to FIG. 7, which schematically illustrates a model region with a rectangular bounded region identifying Hexclusters and/or portions of Hexclusters for which predictions are to be made according to some embodiments disclosed herein.

As illustrated, a rectangular shaped bounding box covers the majority of a major city to define the portion of the region that mobility predictions of vehicles are to be made within this model region.

Different embodiments are available for how provided model regions may be used to create model scopes. In one embodiment, only trips strictly within the defined model region are considered. In such cases, Hexcluster A in FIG. 7 may only describe trips involving H3 cells that are within the rectangle towards the bottom edge of the hexagon. Trips that originate or terminate outside the model region will not be considered.

In one embodiment, the model region provided by system administrators is updated to include all areas covered by Hexclusters generated from it. In such cases, the model region may, after the Hexcluster generation step, cease to be a rectangle but rather be defined as the area equal to the union of all generated Hexclusters. Hence, trips originating and terminating outside the initially defined model region (rectangle) can be captured as long as the entirety of such trips is contained in the updated model region.

Either embodiment may provide that all trips within the model region defined by system administrators can be captured by location prediction models. The choice rests solely on how trips at the boundary of such regions should be dealt with.

Although discussed herein in the context of mobility prediction, such application is by way of example and non-limiting. For example, embodiments herein may be used to predict service level requirements and/or resource availability in many contexts such as predicting connectivity in a model region. Additionally, while examples of cell clusters described herein may be defined in a two-dimensional model region, embodiments disclosed herein may be applicable to model regions in three or more dimensions. One example, many include predicting cell and/or cell cluster characteristics for elements in the model region that corresponds to three-dimensional spaces such multi-floor buildings.

Additionally, embodiments herein may be used to predict the next future data demands in a model region that includes cells that correspond to data sources.

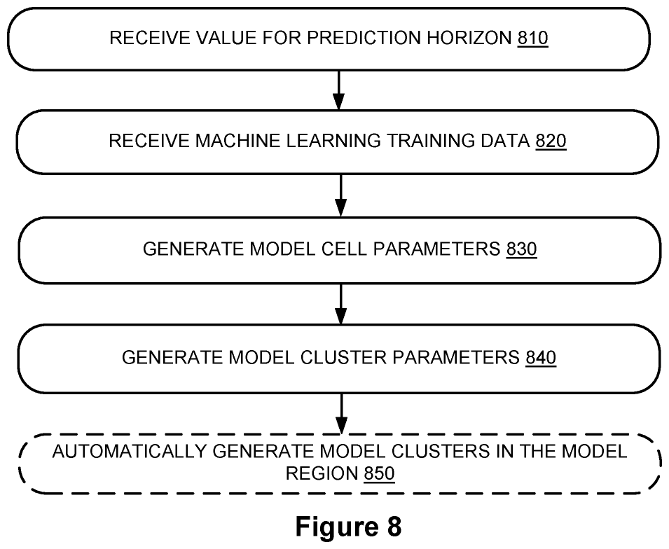

Reference is now made to FIG. 8, which is a flow chart of operations according to some embodiments of the present disclosure. Operations may include receiving (block 810), into a machine learning model, a value for a prediction horizon, Tw, that defines a future time interval for generating predicted data corresponding to an element in a model region. Operations may include receiving (block 820) machine learning training data. In some embodiments, the machine learning data may include data corresponding to previous element activity in the model region. The model region may include at least one model cluster. Each model cluster includes multiple model cells that are adjacent one another.

Operations may include generating (block 830) model cell parameters that define a cell size and/or a cell geometry.

Operations may include generating (block 840) model cluster parameters that include a cluster geometry, a cluster centroid value that identifies a center of the model cluster and/or a cluster radius value that defines a quantity of model cells from the cluster centroid value to an edge of the model cluster. In some embodiments, the model cluster parameters include a cluster overlap that defines a quantity of model cells that are included in adjacent model clusters.

Some embodiments provide that the machine learning training data includes a current position of the element in the model region, one or more previous positions of the element in the model region, and a future position of the element in the model region. In some embodiments, the previous position may include multiple previous positions of the element in the model region

In some embodiments, the model region is two-dimensional. In such embodiments, the cell geometry may be a two-dimensional shape in the model region and the cluster geometry may be the same or a different two-dimensional shape than the model cell. As described in reference to examples provided herein, the two-dimensional shape may be a hexagonal shape. Some embodiments provide that the two-dimensional shape may include any two dimensional shape and/or combination of two dimensional shapes.

In some embodiments, instead of a single model cluster, the model region may include multiple different model clusters. In such embodiments, methods herein may optionally include automatically generating (block 850) the model clusters in the model region based on the model cluster parameters. Some embodiments provide that automatically generating the model clusters in the model region is performed recursively.

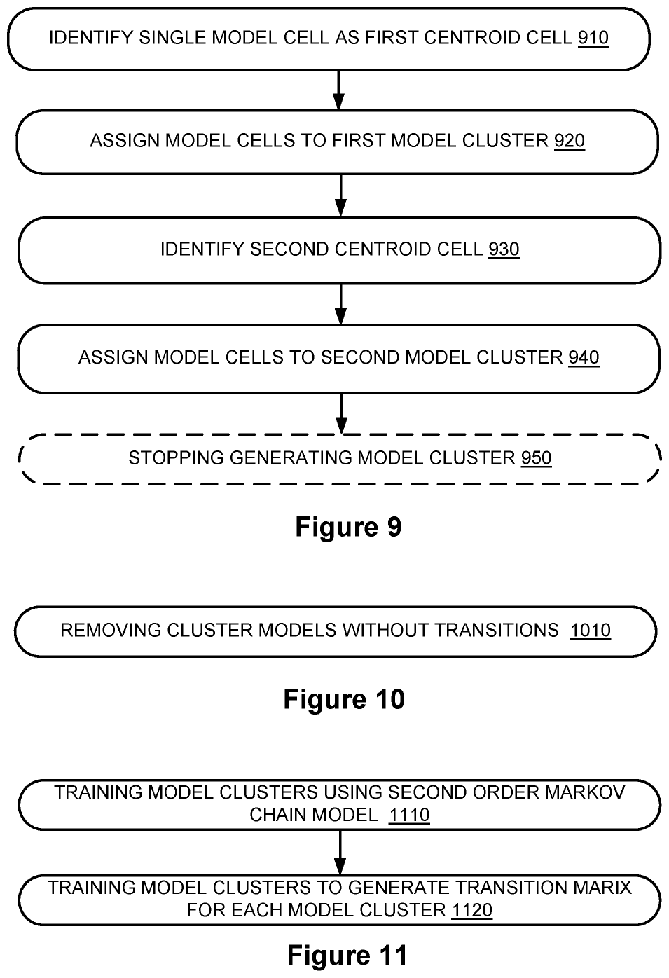

Reference is now made to FIG. 9, which is a flow chart of operations for automatically generating model clusters described in FIG. 8 according to some embodiments of the present disclosure.

Some embodiments provide that automatically generating the model clusters in the model region includes identifying (block 910) a single model cell of the cells in the model region as a first centroid cell corresponding to a first model cluster of the model clusters. Embodiments may include assigning (920) each of the model cells that are within the cluster radius value of the first centroid cell to be in the first model cluster. If the model region is not covered by the model clusters, operations further include identifying (block 940) a second centroid cell based on the first centroid cell, the cluster radius value and the cluster overlap. Operation may further include assigning (block 940) each of the model cells that are within the cluster radius value of the second centroid cell to be in a second model cluster of the plurality of clusters. Some embodiments may optionally include stopping generating (block 950) ones of the model clusters based on the model region being covered with model clusters.

Brief reference is now made to FIG. 10, which is a flow chart of operations according to some embodiments of the present disclosure. Operations may include removing (block 1010) ones of the cluster models that are without transitions of elements in the machine learning training data. Cluster models that have no transitions may represent areas of the model region that are not expected to have future element activity for any one of a number of reasons. For example, in the context of geographical model regions, certain clusters may be located in areas that may not and will not have element activity based on accessibility.

Brief reference is now made to FIG. 11, which is a flow chart of operations according to some embodiments of the present disclosure. Operations may include training (block 1110) the model clusters using a second order Markov chain model. Some embodiments provide that machine learning techniques other than the second order Markov chain model may be used. For example, any of a variety of machine learning models may be used include artificial neural networks and/or other orders of Markov chain model. Some embodiments provide that multiple previous positions may be used depending on the order of the model and/or on the type of machine learning model. Operations may include training (block 1120) the at least one model cluster to generate a transition matrix corresponding to each of the at least one model clusters.

In some embodiments, responsive to one of the model clusters including a maximum number of transitions of elements, the cluster radius value corresponding to that model cluster may be reduced. Such reductions may cause the size and computational load corresponding to the model cluster to be reduced. For example, model clusters in the model region that correspond to higher element transitions may be divided into smaller cluster regions to increase processing efficiency of that cluster model.

Some embodiments provide that after training a model cluster, an inference operation may be performed that is based on the transition matrix and that provides a probable future model cell that the element will be in at Tw and a confidence value corresponding the probable future model cell in response to receiving a current position of the element in the model region and a previous position of the element in the model region.

In some embodiments, in response to the current position and the previous position being in an overlapping area of multiple ones of the at least one model cluster, the inference operation uses weighted averages corresponding to the multiple ones of the at least one model cluster. Some embodiments provide that the probable future model cell include a future position of the element in the model region. Some embodiments provide that the probable future model cell includes a confidence value that corresponds to a future position in the model region.

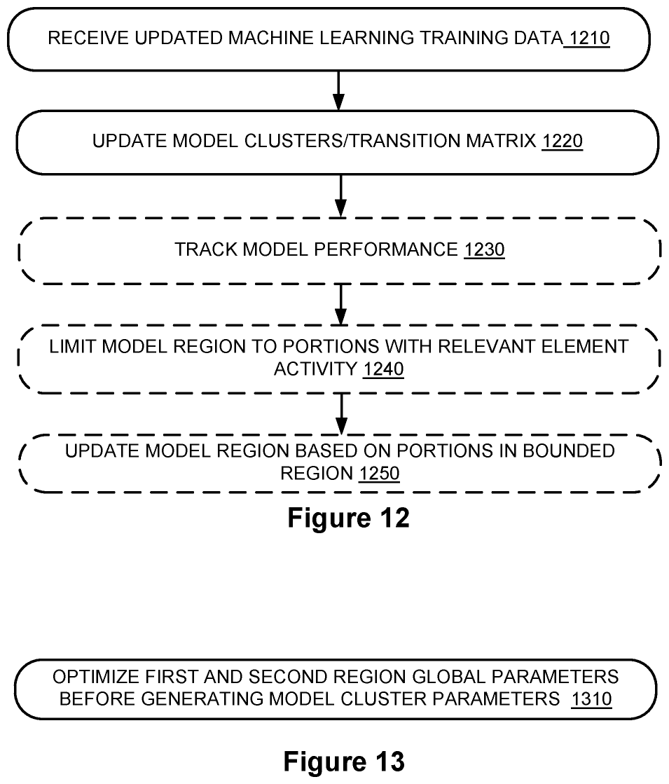

Reference is now made to FIG. 12, which is a flow chart of operations according to some embodiments of the present disclosure. Operations may include receiving (block 1210) updated machine learning training data that includes data corresponding to updated transitions of elements in the model region. Operations may include updating (block 1220) the at least one model cluster and/or a transition matrix responsive to receiving the updated machine learning data. Optional operations may include tracking (block 1230) model performance by comparing predicted results with actual results of the at least one model cluster and limiting (block 1240) the model region to portions that include relevant element activity and/or transitions. In some embodiments, limiting the model region may include selecting a bounded region that includes less than all of one or more model clusters.

Optional operations may include updating (block 1250) the model region to include a model cluster that includes portions in the bounded region. In some embodiments, the model clusters include a first model cluster and a second model cluster, generating the model parameters includes generating first model cluster parameters corresponding to the first model cluster and second model cluster parameters corresponding to the second model cluster, and the first model cluster parameters are different from the second model cluster parameters.

Brief reference is now made to FIG. 13, which is a flow chart of operations according to some embodiments of the present disclosure. According to some embodiments, operations may include optimizing (block 1310) first model cluster global parameters and second model cluster global parameters before generating model cluster parameters corresponding to the first and second model clusters. In some embodiments, a first model cluster may include first model cells including first model cell parameters and a second model cluster that is adjacent the first model cluster includes second ones of the model cells including second model cell parameters that are different from the first model cell parameters.

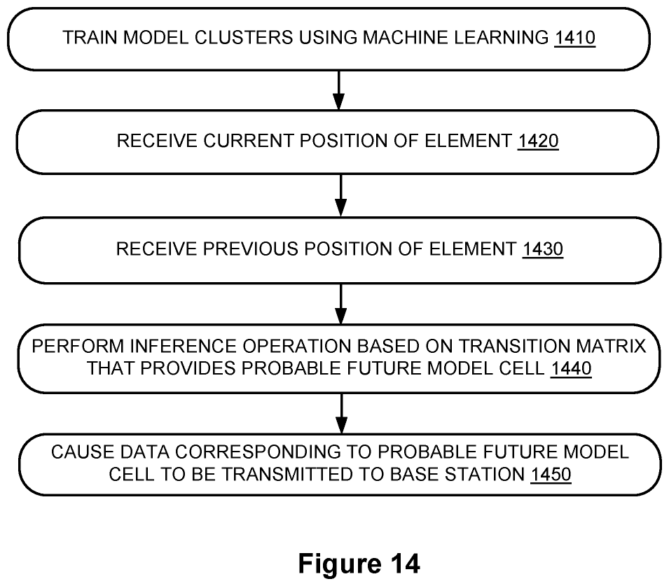

Reference is now made to FIG. 14, which is a flow chart of operations according to some embodiments of the present disclosure. Operations include training (block 1410) ones of the model clusters using machine learning methods, receiving (1420) a current position of the element in the model region, and receiving (block 1430) a previous position of the element in the model region. Embodiments provide performing (block 1440) an inference operation that is based on a transition matrix and that provides a probable future model cell that the element will be in at Tw and a confidence value corresponding to the probable future model cell in response to receiving a current position of the element in the model region and a previous position of the element in the model region. Operations may further include causing (block 1450) data corresponding the probable future model cell to be transmitted to a base station.

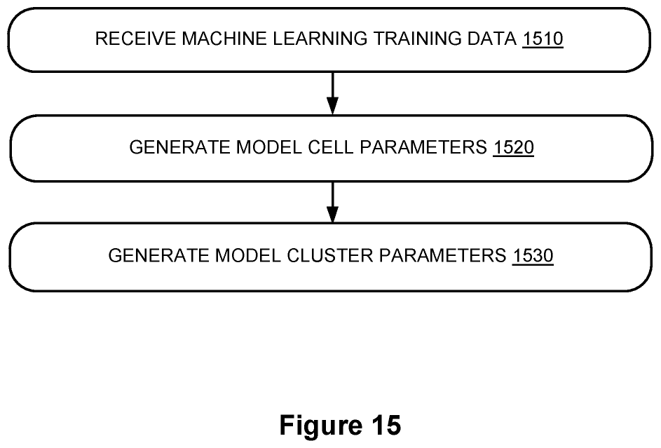

Reference is now made to FIG. 15, which is a flow chart of operations according to some embodiments of the present disclosure. Operations include receiving (block 1510) machine learning training data that includes data corresponding to previous element activity in the model region. Some embodiments provide that the model region includes at least one model cluster and each model cluster includes multiple model cells that are adjacent to one another. Operations include generating (block 1520), using the machine learning model, model cell parameters that define a cell size and a cell geometry and generating (block 1530), using the machine learning model, model cluster parameters that include a cluster geometry, a cluster centroid value that identifies a center of the model cluster and a cluster radius value that defines a quantity of model cells from the cluster centroid value to an edge of the model cluster.

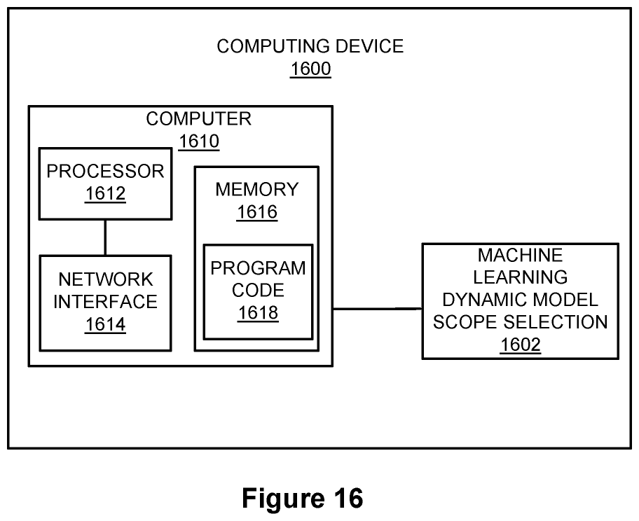

Now that the operations of the various components have been described, operations specific to a computing device 1600 for a radio network (implemented using the structure of the block diagram of FIG. 16) will now be discussed according to various embodiments of the present disclosure. As shown, computing device 1600 may include network interface circuitry 1614 (also referred to as a network interface) configured to provide communications with other nodes of the radio network. Computing device 1600 may also include a processing circuitry 1612 (also referred to as a processor) coupled to the network interface circuitry, and memory circuitry 1616 (also referred to as memory) coupled to the processing circuitry 1612. The memory circuitry 1616 may include computer readable program code that when executed by the processing circuitry 1612 causes the processing circuitry 1612 to perform operations. Further, modules may be stored in memory 1616, and these modules may provide instructions so that when the instructions of a module are executed by respective computer processing circuitry of a machine learning dynamic model scope selection model 1602 according to embodiments disclosed herein.

As discussed herein, operations of the computing device 1600 may be performed by a machine learning dynamic model scope selection model 1602 and/or network interface circuitry 1614. For example, a machine learning dynamic model scope selection model 1602 may control network interface circuitry 1614 to transmit communications through network interface circuitry 1614 to one or more network nodes and/or to receive communications through network interface circuitry from one or more network nodes. Each of the operations described herein can be combined and/or omitted in any combination with each other, and it is contemplated that all such combinations fall within the spirit and scope of this disclosure.

In some embodiments, the computing device 1600 may include multiple computing devices 1600 that are configured to perform operations described herein. Some embodiments provide that the multiple computing devices 1600 are co-located at a common network node, while other embodiments provide that one or more of the multiple computer devices 1600 are decentralized from one another and are configured to perform operations described herein at different network nodes. For example, embodiments described herein may be performed by a cluster of computing devices 1600.

As provided herein, methods, systems and apparatus may automatically and dynamically provide example services such as location prediction for large scale geographies. We introduced the concept of Hexclusters to subset large geographical areas into smaller groups of H3 cells. Hexclusters may overlap to solve the problem of vehicles crossing from one model scope to another

Hexclusters can be generated recursively within certain model regions. This may substantially reduce the amount of manual work required by system administrators of a global service provider.

Models for different Hexclusters can be trained independently. Key parameters such as H3 levels and prediction horizon can be finetuned automatically and in a data-driven fashion. Embodiments herein may provide flexibility and may generalizes well to different prediction scenarios and using different geometrical approaches.

The various operations described herein may be optional with respect to some embodiments of methods performed by a computing device for radio network.

Example embodiments are discussed below. Reference numbers/letters are provided in parenthesis by way of example/illustration without limiting example embodiments to particular elements indicated by reference numbers/letters.

### EMBODIMENTS

Embodiment 1. A method performed by a computing device (1602, 1600) in a network, the method comprising:
receiving (810), into a machine learning model, a value for a prediction horizon, Tw, that defines a future time interval for generating predicted data corresponding to an element in a model region;
receiving (820) machine learning training data that includes data corresponding to previous element activity in the model region, wherein the model region comprises at least one model cluster, and wherein each of the at least one model cluster comprises a plurality of model cells that are adjacent one another;
generating (830), using the machine learning model, model cell parameters that define a cell size and a cell geometry; and
generating (840), using the machine learning model, model cluster parameters that comprise a cluster geometry, a cluster centroid value that identifies a center of the model cluster and a cluster radius value that defines a quantity of model cells from the cluster centroid value to an edge of the model cluster.

Embodiment 2. The method of embodiment 1, wherein the model cluster parameters further comprise a cluster overlap that defines a quantity of model cells that are included in adjacent model clusters.

Embodiment 3. The method of any of embodiments 1-2, wherein the machine learning training data comprises:
a current position of the element in the model region;
a previous position of the element in the model region; and
a future position of the element in the model region.

Embodiment 4. The method of any of embodiments 1-3, wherein the model region is two-dimensional,
wherein the cell geometry comprises a two-dimensional shape in the model region, and
wherein cluster geometry comprises the two-dimensional shape.

Embodiment 5. The method of embodiment 4, wherein the two-dimensional shape comprises a hexagonal shape.

Embodiment 6. The method of any of embodiments 1-5, wherein the at least one model cluster comprises a plurality of model clusters, wherein the method further comprises automatically generating (850) the plurality of model clusters in the model region based on the model cluster parameters.

Embodiment 7. The method of embodiment 6, wherein automatically generating the plurality of model clusters in the model region is performed recursively.

Embodiment 8. The method of embodiment 6, wherein automatically generating the plurality of model clusters in the model region comprises:
identifying (910) a single model cell of the plurality of cells in the model region as a first centroid cell corresponding to a first model cluster of the plurality of model clusters;
assigning (920) each of the model cells that are within the cluster radius value of the first centroid cell to be in the first model cluster;
if the model region is not covered by the plurality of model clusters, identifying (930) a second centroid cell based on the first centroid cell, the cluster radius value and the cluster overlap; and
assigning (940) each of the model cells that are within the cluster radius value of the second centroid cell to be in a second model cluster of the plurality of clusters.

Embodiment 9. The method of embodiment 8, further comprising stopping (950) generating model clusters of the plurality of clusters based on the model region being covered with model clusters.

Embodiment 10. The method of any of embodiments 1-9, further comprising removing (1010) ones of the at least one cluster model that are without transitions of elements in the machine learning training data.

Embodiment 11. The method of any of embodiments 1-10, further comprising training (1110) the at least one model cluster using a second order Markov chain model.

Embodiment 12. The method of any of embodiments 1-10, further comprising training (1120) the at least one model cluster to generate a transition matrix corresponding to each of the at least one model clusters.

Embodiment 13. The method of any of embodiments 1-11, wherein, responsive to one of the at least one model clusters including a maximum number of transitions of elements, reducing the cluster radius value corresponding to that model cluster.

Embodiment 14. The method of any of embodiments 12-13, wherein after training the at least one model cluster, performing an inference operation that is based on the transition matrix and that provides a probable future model cell that the element will be in at Tw and a confidence value corresponding the probable future model cell in response to receiving a current position of the element in the model region and a previous position of the element in the model region.

Embodiment 15. The method of embodiment 14, wherein in response to the current position and the previous position being in an overlapping area of multiple ones of the at least one model cluster, the inference operation uses weighted averages corresponding to the multiple ones of the at least one model cluster.

Embodiment 16. The method of embodiment 14, wherein the probable future model cell comprises a future position of the element in the model region.

Embodiment 17. The method of any of embodiments 14-16, wherein the probable future model cell comprises a confidence value that corresponds to a future position in the model region.

Embodiment 18. The method of any of embodiments 1-17, further comprising:
receiving (1210) updated machine learning training data that includes data corresponding to updated transitions of elements in the model region; and
updating (1220) the at least one model cluster and/or a transition matrix responsive to receiving the updated machine learning data.

Embodiment 19. The method of any of embodiments 1-18, further comprising tracking (1230) model performance by comparing predicted results with actual results of the at least one model cluster.

Embodiment 20. The method of any of embodiments 1-19, further comprising limiting (1240) the model region to portions that include relevant element activity and/or transitions.

Embodiment 21. The method of embodiment 20, wherein limiting the model region comprises selecting a bounded region that includes less than all of the at least one model cluster.

Embodiment 22. The method of embodiment 21, further comprising updating (1250) the model region to include the at least one model cluster that includes portions in the bounded region.

Embodiment 23. The method of any of embodiments 1-19,
wherein the at least one model cluster comprises a first model cluster and a second model cluster that is different from the first model cluster,
wherein generating the model parameters comprises generating first model cluster parameters corresponding to the first model cluster and second model cluster parameters corresponding to the second model cluster, and
wherein the first model cluster parameters are different from the second model cluster parameters.

Embodiment 24. The method of embodiment 23, further comprising optimizing (1310) first model cluster global parameters and second model cluster global parameters before generating model cluster parameters corresponding to the first and second model clusters.

Embodiment 25. The method of any of embodiments 1-24, wherein a first model cluster of the at least one model cluster comprises first ones of the plurality of model cells including first model cell parameters, and
wherein a second model cluster of the at least one model cluster that is adjacent the first model cluster comprises second ones of the plurality of model cells including second model cell parameters that are different from the first model cell parameters.

Embodiment 26. The method of any of embodiments 1-25, further comprising:
training (1410) ones of the at least one model cluster using machine learning methods,
receiving (1420) a current position of the element in the model region;
receiving (1430) a previous position of the element in the model region;
performing (1440) an inference operation that is based on a transition matrix and that provides a probable future model cell that the element will be in at Tw and a confidence value corresponding the probable future model cell in response to receiving a current position of the element in the model region and a previous position of the element in the model region; and
causing (1450) data corresponding the probable future model cell to be transmitted to a base station.

Embodiment 27. A computing device (1602, 1600) comprising machine learning dynamic model scope selection for a radio network, the computing device comprising:
at least one processor (1612);
at least one memory (1616) connected to the at least one processor (1612) and storing program code that is executed by the at least one processor to perform operations comprising:
receiving (1510) machine learning training data that includes data corresponding to previous element activity in the model region, wherein the model region comprises at least one model cluster, and wherein each of the at least one model cluster comprises a plurality of model cells that are adjacent one another;
generating (1520), using the machine learning model, model cell parameters that define a cell size and a cell geometry; and
generating (1530), using the machine learning model, model cluster parameters that comprise a cluster geometry, a cluster centroid value that identifies a center of the model cluster and a cluster radius value that defines a quantity of model cells from the cluster centroid value to an edge of the model cluster.

Embodiment 28. The computing device (1602, 1600) of Embodiment 27, wherein the at least one memory (1616) connected to the at least one processor and storing program code that is executed by the at least one processor to perform operations according to Embodiments 2 to 26.

Embodiment 29. A computer program comprising program code to be executed by processing circuitry (1612) of a computing device (1602, 1600) comprising machine learning dynamic model scope selection for a radio network, whereby execution of the program code causes the computing device to perform operations comprising:
receiving (1510) machine learning training data that includes data corresponding to previous element activity in the model region, wherein the model region comprises at least one model cluster, and wherein each of the at least one model cluster comprises a plurality of model cells that are adjacent one another;
generating (1520), using the machine learning model, model cell parameters that define a cell size and a cell geometry; and
generating (1530), using the machine learning model, model cluster parameters that comprise a cluster geometry, a cluster centroid value that identifies a center of the model cluster and a cluster radius value that defines a quantity of model cells from the cluster centroid value to an edge of the model cluster.

Embodiment 30. The computer program of Embodiment 29, whereby execution of the program code causes the computing device (1602, 1600) to perform operations according to any of Embodiments 2 to 26.

Embodiment 31. A computer program product comprising a non-transitory storage medium including program code to be executed by processing circuitry (1612) of a computing device (1602, 1600) comprising machine learning dynamic model scope selection for a radio network, whereby execution of the program code causes the computing device to perform operations comprising:
receiving (1510) machine learning training data that includes data corresponding to previous element activity in the model region, wherein the model region comprises at least one model cluster, and wherein each of the at least one model cluster comprises a plurality of model cells that are adjacent one another;
generating (1520), using the machine learning model, model cell parameters that define a cell size and a cell geometry; and
generating (1530), using the machine learning model, model cluster parameters that comprise a cluster geometry, a cluster centroid value that identifies a center of the model cluster and a cluster radius value that defines a quantity of model cells from the cluster centroid value to an edge of the model cluster.

Embodiment 32. The computer program product of Embodiment 31, whereby execution of the program code causes the computing device (1602, 1600) to perform operations according to any of Embodiments 2 to 26.

Explanations for abbreviations from the above disclosure are provided below.

| Abbreviation | Explanation |
|---|---|
| 3GPP | 3rd Generation Partnership Project |
| 5G | 5th Generation |
| 5GC | 5G Core Network |
| CN | Core Network |
| CVC | Connected Vehicle Cloud |
| EDA | Ericsson Device Analytics |
| eNB | Evolved NodeB (a radio base station in LTE) |
| gNB | A radio base station in NR. |
| HTTP | Hypertext Transfer Protocol |
| LTE | Long Term Evolution |
| MNO | Mobile Network Operator |
| NR | New Radio |
| RAN | Radio Access Network |
| Tw | Prediction Horizon, length of time window |
| UE | User Equipment |
| X2 | Interface/reference point between two eNBs. |
| Xn | Interface/reference point between two gNBs. |

### REFERENCES

1. N. C. N. Z. X. S. a. J. W. M. N. Lu, “Connected Vehicles: Solutions and Challenges,” vol. 1, no. 4, 2014.
2. “Device Analytics,” Ericsson AB, [Online]. Available: https://www.ericsson.com/en/portfolio/digital-services/transform-business/device-and-network-testing/device-and-application-verification/device-analytics.
3. “Connected Vehicles,” Ericsson AB, [Online]. Available: https://www.ericsson.com/en/internet-of-things/automotive.
4. H. Z. a. L. Dai, “Mobility Prediction: A Survey on State-of-the-Art Schemes and Future Applications,”
5. I. Brodsky, “H3: Uber's Hexagonal Hierarchical Spatial Index,” Uber, 27 Jun. 2018. [Online]. Available: https://eng.uber.com/h3/.
6. “H3,” Uber, [Online]. Available: https://h3geo.org/docs/core-library/restable. “OpenStreetMap,” [Online]. Available: https://www.openstreetmap.org/

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

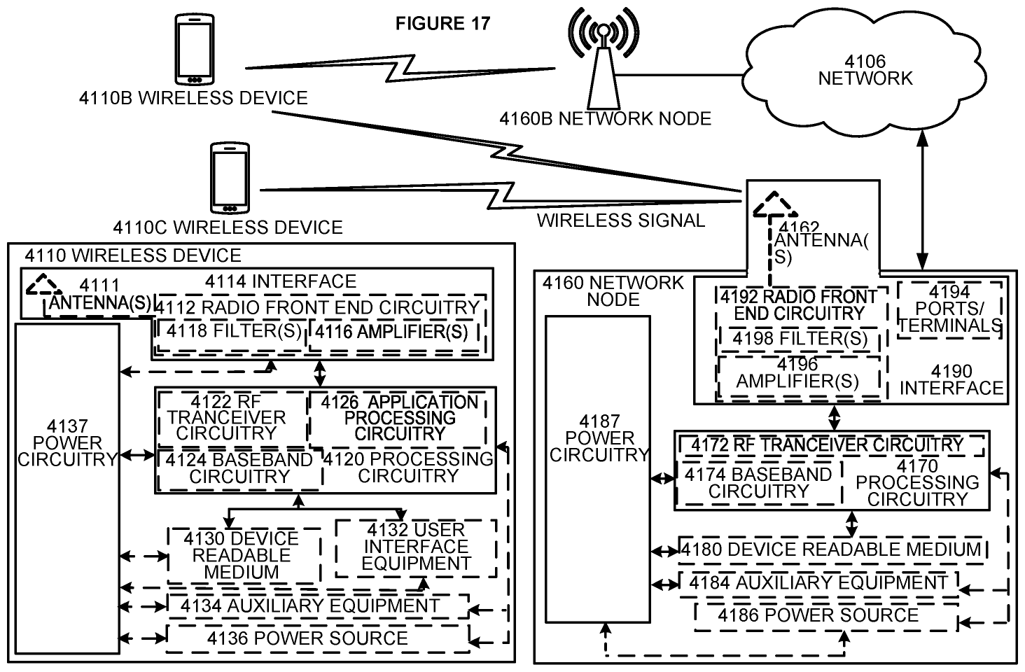

FIG. 17 is a block diagram of a wireless network in accordance with some embodiments.

Although the subject matter described herein may be implemented in any appropriate type of system using any suitable components, the embodiments disclosed herein are described in relation to a wireless network, such as the example wireless network illustrated in FIG. 17. For simplicity, the wireless network of FIG. 17 only depicts network 4106, network nodes 4160 and 4160b, and WDs 4110, 4110b, and 4110c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 4160 and wireless device (WD) 4110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 4106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 4160 and WD 4110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, core nodes, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 17, network node 4160 includes processing circuitry 4170, device readable medium 4180, interface 4190, auxiliary equipment 4184, power source 4186, power circuitry 4187, and antenna 4162. Although network node 4160 illustrated in the example wireless network of FIG. 17 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 4160 are depicted as single boxes located within a larger box, or nested within multiple boxes, in practice, a network node may comprise multiple different physical components that make up a single illustrated component (e.g., device readable medium 4180 may comprise multiple separate hard drives as well as multiple RAM modules).

Similarly, network node 4160 may be composed of multiple physically separate components (e.g., a NodeB component and a RNC component, or a BTS component and a BSC component, etc.), which may each have their own respective components. In certain scenarios in which network node 4160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 4160 may be configured to support multiple radio access technologies (RATs). In such embodiments, some components may be duplicated (e.g., separate device readable medium 4180 for the different RATs) and some components may be reused (e.g., the same antenna 4162 may be shared by the RATs). Network node 4160 may also include multiple sets of the various illustrated components for different wireless technologies integrated into network node 4160, such as, for example, GSM, WCDMA, LTE, NR, WiFi, or Bluetooth wireless technologies. These wireless technologies may be integrated into the same or different chip or set of chips and other components within network node 4160.

Processing circuitry 4170 is configured to perform any determining, calculating, or similar operations (e.g., certain obtaining operations) described herein as being provided by a network node. These operations performed by processing circuitry 4170 may include processing information obtained by processing circuitry 4170 by, for example, converting the obtained information into other information, comparing the obtained information or converted information to information stored in the network node, and/or performing one or more operations based on the obtained information or converted information, and as a result of said processing making a determination.

Processing circuitry 4170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 4160 components, such as device readable medium 4180, network node 4160 functionality. For example, processing circuitry 4170 may execute instructions stored in device readable medium 4180 or in memory within processing circuitry 4170. Such functionality may include providing any of the various wireless features, functions, or benefits discussed herein. In some embodiments, processing circuitry 4170 may include a system on a chip (SOC).

In some embodiments, processing circuitry 4170 may include one or more of radio frequency (RF) transceiver circuitry 4172 and baseband processing circuitry 4174. In some embodiments, radio frequency (RF) transceiver circuitry 4172 and baseband processing circuitry 4174 may be on separate chips (or sets of chips), boards, or units, such as radio units and digital units. In alternative embodiments, part or all of RF transceiver circuitry 4172 and baseband processing circuitry 4174 may be on the same chip or set of chips, boards, or units

In certain embodiments, some or all of the functionality described herein as being provided by a network node, base station, eNB or other such network device may be performed by processing circuitry 4170 executing instructions stored on device readable medium 4180 or memory within processing circuitry 4170. In alternative embodiments, some or all of the functionality may be provided by processing circuitry 4170 without executing instructions stored on a separate or discrete device readable medium, such as in a hard-wired manner. In any of those embodiments, whether executing instructions stored on a device readable storage medium or not, processing circuitry 4170 can be configured to perform the described functionality. The benefits provided by such functionality are not limited to processing circuitry 4170 alone or to other components of network node 4160, but are enjoyed by network node 4160 as a whole, and/or by end users and the wireless network generally.

Device readable medium 4180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 4170. Device readable medium 4180 may store any suitable instructions, data or information, including a computer program, software, an application including one or more of logic, rules, code, tables, etc. and/or other instructions capable of being executed by processing circuitry 4170 and, utilized by network node 4160. Device readable medium 4180 may be used to store any calculations made by processing circuitry 4170 and/or any data received via interface 4190. In some embodiments, processing circuitry 4170 and device readable medium 4180 may be considered to be integrated.

Interface 4190 is used in the wired or wireless communication of signaling and/or data between network node 4160, network 4106, and/or WDs 4110. As illustrated, interface 4190 comprises port(s)/terminal(s) 4194 to send and receive data, for example to and from network 4106 over a wired connection. Interface 4190 also includes radio front end circuitry 4192 that may be coupled to, or in certain embodiments a part of, antenna 4162. Radio front end circuitry 4192 comprises filters 4198 and amplifiers 4196. Radio front end circuitry 4192 may be connected to antenna 4162 and processing circuitry 4170. Radio front end circuitry may be configured to condition signals communicated between antenna 4162 and processing circuitry 4170. Radio front end circuitry 4192 may receive digital data that is to be sent out to other network nodes or WDs via a wireless connection. Radio front end circuitry 4192 may convert the digital data into a radio signal having the appropriate channel and bandwidth parameters using a combination of filters 4198 and/or amplifiers 4196. The radio signal may then be transmitted via antenna 4162. Similarly, when receiving data, antenna 4162 may collect radio signals which are then converted into digital data by radio front end circuitry 4192. The digital data may be passed to processing circuitry 4170. In other embodiments, the interface may comprise different components and/or different combinations of components.

In certain alternative embodiments, network node 4160 may not include separate radio front end circuitry 4192, instead, processing circuitry 4170 may comprise radio front end circuitry and may be connected to antenna 4162 without separate radio front end circuitry 4192. Similarly, in some embodiments, all or some of RF transceiver circuitry 4172 may be considered a part of interface 4190. In still other embodiments, interface 4190 may include one or more ports or terminals 4194, radio front end circuitry 4192, and RF transceiver circuitry 4172, as part of a radio unit (not shown), and interface 4190 may communicate with baseband processing circuitry 4174, which is part of a digital unit (not shown).

Antenna 4162 may include one or more antennas, or antenna arrays, configured to send and/or receive wireless signals. Antenna 4162 may be coupled to radio front end circuitry 4190 and may be any type of antenna capable of transmitting and receiving data and/or signals wirelessly. In some embodiments, antenna 4162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 4162 may be separate from network node 4160 and may be connectable to network node 4160 through an interface or port.

Antenna 4162, interface 4190, and/or processing circuitry 4170 may be configured to perform any receiving operations and/or certain obtaining operations described herein as being performed by a network node. Any information, data and/or signals may be received from a wireless device, another network node and/or any other network equipment. Similarly, antenna 4162, interface 4190, and/or processing circuitry 4170 may be configured to perform any transmitting operations described herein as being performed by a network node. Any information, data and/or signals may be transmitted to a wireless device, another network node and/or any other network equipment.

Power circuitry 4187 may comprise, or be coupled to, power management circuitry and is configured to supply the components of network node 4160 with power for performing the functionality described herein. Power circuitry 4187 may receive power from power source 4186. Power source 4186 and/or power circuitry 4187 may be configured to provide power to the various components of network node 4160 in a form suitable for the respective components (e.g., at a voltage and current level needed for each respective component). Power source 4186 may either be included in, or external to, power circuitry 4187 and/or network node 4160. For example, network node 4160 may be connectable to an external power source (e.g., an electricity outlet) via an input circuitry or interface such as an electrical cable, whereby the external power source supplies power to power circuitry 4187. As a further example, power source 4186 may comprise a source of power in the form of a battery or battery pack which is connected to, or integrated in, power circuitry 4187. The battery may provide backup power should the external power source fail. Other types of power sources, such as photovoltaic devices, may also be used.

Alternative embodiments of network node 4160 may include additional components beyond those shown in FIG. 17 that may be responsible for providing certain aspects of the network node's functionality, including any of the functionality described herein and/or any functionality necessary to support the subject matter described herein. For example, network node 4160 may include user interface equipment to allow input of information into network node 4160 and to allow output of information from network node 4160. This may allow a user to perform diagnostic, maintenance, repair, and other administrative functions for network node 4160.

As used herein, user equipment (UE) or communication service consumer (CSC) device refers to a device capable, configured, arranged and/or operable to communicate wirelessly with network nodes and/or other wireless devices. Unless otherwise noted, the term UE may be used interchangeably herein with user equipment, user device, communication device, wireless device (WD), and/or CSC device. Communicating wirelessly may involve transmitting and/or receiving wireless signals using electromagnetic waves, radio waves, infrared waves, and/or other types of signals suitable for conveying information through air. In some embodiments, a UE may be configured to transmit and/or receive information without direct human interaction. For instance, a UE may be designed to transmit information to a network on a predetermined schedule, when triggered by an internal or external event, or in response to requests from the network. Examples of a UE include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A UE may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a UE may represent a machine or other device that performs monitoring and/or measurements, and transmits the results of such monitoring and/or measurements to another UE and/or a network node. The UE may in this case be a machine-to-machine (M2M) device, which may in a 3GPP context be referred to as an MTC device. As one particular example, the UE may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a UE may represent a vehicle or other equipment that is capable of monitoring and/or reporting on its operational status or other functions associated with its operation. A UE as described above may represent the endpoint of a wireless connection, in which case the device may be referred to as a wireless terminal. Furthermore, a UE as described above may be mobile, in which case it may also be referred to as a mobile device or a mobile terminal.

As illustrated, wireless device 4110 includes antenna 4111, interface 4114, processing circuitry 4120, device readable medium 4130, user interface equipment 4132, auxiliary equipment 4134, power source 4136 and power circuitry 4137. WD 4110 may include multiple sets of one or more of the illustrated components for different wireless technologies supported by WD 4110, such as, for example, GSM, WCDMA, LTE, NR, WiFi, WiMAX, or Bluetooth wireless technologies, just to mention a few. These wireless technologies may be integrated into the same or different chips or set of chips as other components within WD 4110.

Antenna 4111 may include one or more antennas or antenna arrays, configured to send and/or receive wireless signals, and is connected to interface 4114. In certain alternative embodiments, antenna 4111 may be separate from WD 4110 and be connectable to WD 4110 through an interface or port. Antenna 4111, interface 4114, and/or processing circuitry 4120 may be configured to perform any receiving or transmitting operations described herein as being performed by a WD. Any information, data and/or signals may be received from a network node and/or another WD. In some embodiments, radio front end circuitry and/or antenna 4111 may be considered an interface.

As illustrated, interface 4114 comprises radio front end circuitry 4112 and antenna 4111. Radio front end circuitry 4112 comprise one or more filters 4118 and amplifiers 4116. Radio front end circuitry 4114 is connected to antenna 4111 and processing circuitry 4120, and is configured to condition signals communicated between antenna 4111 and processing circuitry 4120. Radio front end circuitry 4112 may be coupled to or a part of antenna 4111. In some embodiments, WD 4110 may not include separate radio front end circuitry 4112; rather, processing circuitry 4120 may comprise radio front end circuitry and may be connected to antenna 4111. Similarly, in some embodiments, some or all of RF transceiver circuitry 4122 may be considered a part of interface 4114. Radio front end circuitry 4112 may receive digital data that is to be sent out to other network nodes or WDs via a wireless connection. Radio front end circuitry 4112 may convert the digital data into a radio signal having the appropriate channel and bandwidth parameters using a combination of filters 4118 and/or amplifiers 4116. The radio signal may then be transmitted via antenna 4111. Similarly, when receiving data, antenna 4111 may collect radio signals which are then converted into digital data by radio front end circuitry 4112. The digital data may be passed to processing circuitry 4120. In other embodiments, the interface may comprise different components and/or different combinations of components.

Processing circuitry 4120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 4110 components, such as device readable medium 4130, WD 4110 functionality. Such functionality may include providing any of the various wireless features or benefits discussed herein. For example, processing circuitry 4120 may execute instructions stored in device readable medium 4130 or in memory within processing circuitry 4120 to provide the functionality disclosed herein.

As illustrated, processing circuitry 4120 includes one or more of RF transceiver circuitry 4122, baseband processing circuitry 4124, and application processing circuitry 4126. In other embodiments, the processing circuitry may comprise different components and/or different combinations of components. In certain embodiments processing circuitry 4120 of WD 4110 may comprise a SOC. In some embodiments, RF transceiver circuitry 4122, baseband processing circuitry 4124, and application processing circuitry 4126 may be on separate chips or sets of chips. In alternative embodiments, part or all of baseband processing circuitry 4124 and application processing circuitry 4126 may be combined into one chip or set of chips, and RF transceiver circuitry 4122 may be on a separate chip or set of chips. In still alternative embodiments, part or all of RF transceiver circuitry 4122 and baseband processing circuitry 4124 may be on the same chip or set of chips, and application processing circuitry 4126 may be on a separate chip or set of chips. In yet other alternative embodiments, part or all of RF transceiver circuitry 4122, baseband processing circuitry 4124, and application processing circuitry 4126 may be combined in the same chip or set of chips. In some embodiments, RF transceiver circuitry 4122 may be a part of interface 4114. RF transceiver circuitry 4122 may condition RF signals for processing circuitry 4120.

In certain embodiments, some or all of the functionality described herein as being performed by a WD may be provided by processing circuitry 4120 executing instructions stored on device readable medium 4130, which in certain embodiments may be a computer-readable storage medium. In alternative embodiments, some or all of the functionality may be provided by processing circuitry 4120 without executing instructions stored on a separate or discrete device readable storage medium, such as in a hard-wired manner. In any of those particular embodiments, whether executing instructions stored on a device readable storage medium or not, processing circuitry 4120 can be configured to perform the described functionality. The benefits provided by such functionality are not limited to processing circuitry 4120 alone or to other components of WD 4110, but are enjoyed by WD 4110 as a whole, and/or by end users and the wireless network generally.

Processing circuitry 4120 may be configured to perform any determining, calculating, or similar operations (e.g., certain obtaining operations) described herein as being performed by a WD. These operations, as performed by processing circuitry 4120, may include processing information obtained by processing circuitry 4120 by, for example, converting the obtained information into other information, comparing the obtained information or converted information to information stored by WD 4110, and/or performing one or more operations based on the obtained information or converted information, and as a result of said processing making a determination.

Device readable medium 4130 may be operable to store a computer program, software, an application including one or more of logic, rules, code, tables, etc. and/or other instructions capable of being executed by processing circuitry 4120. Device readable medium 4130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 4120. In some embodiments, processing circuitry 4120 and device readable medium 4130 may be considered to be integrated.

User interface equipment 4132 may provide components that allow for a human user to interact with WD 4110. Such interaction may be of many forms, such as visual, audial, tactile, etc. User interface equipment 4132 may be operable to produce output to the user and to allow the user to provide input to WD 4110. The type of interaction may vary depending on the type of user interface equipment 4132 installed in WD 4110. For example, if WD 4110 is a smart phone, the interaction may be via a touch screen; if WD 4110 is a smart meter, the interaction may be through a screen that provides usage (e.g., the number of gallons used) or a speaker that provides an audible alert (e.g., if smoke is detected). User interface equipment 4132 may include input interfaces, devices and circuits, and output interfaces, devices and circuits. User interface equipment 4132 is configured to allow input of information into WD 4110, and is connected to processing circuitry 4120 to allow processing circuitry 4120 to process the input information. User interface equipment 4132 may include, for example, a microphone, a proximity or other sensor, keys/buttons, a touch display, one or more cameras, a USB port, or other input circuitry. User interface equipment 4132 is also configured to allow output of information from WD 4110, and to allow processing circuitry 4120 to output information from WD 4110. User interface equipment 4132 may include, for example, a speaker, a display, vibrating circuitry, a USB port, a headphone interface, or other output circuitry. Using one or more input and output interfaces, devices, and circuits, of user interface equipment 4132, WD 4110 may communicate with end users and/or the wireless network, and allow them to benefit from the functionality described herein.

Auxiliary equipment 4134 is operable to provide more specific functionality which may not be generally performed by WDs. This may comprise specialized sensors for doing measurements for various purposes, interfaces for additional types of communication such as wired communications etc. The inclusion and type of components of auxiliary equipment 4134 may vary depending on the embodiment and/or scenario.

Power source 4136 may, in some embodiments, be in the form of a battery or battery pack. Other types of power sources, such as an external power source (e.g., an electricity outlet), photovoltaic devices or power cells, may also be used. WD 4110 may further comprise power circuitry 4137 for delivering power from power source 4136 to the various parts of WD 4110 which need power from power source 4136 to carry out any functionality described or indicated herein. Power circuitry 4137 may in certain embodiments comprise power management circuitry. Power circuitry 4137 may additionally or alternatively be operable to receive power from an external power source; in which case WD 4110 may be connectable to the external power source (such as an electricity outlet) via input circuitry or an interface such as an electrical power cable. Power circuitry 4137 may also in certain embodiments be operable to deliver power from an external power source to power source 4136. This may be, for example, for the charging of power source 4136. Power circuitry 4137 may perform any formatting, converting, or other modification to the power from power source 4136 to make the power suitable for the respective components of WD 4110 to which power is supplied.

In the above description of various embodiments of the present disclosure, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

1. A method performed by a computing device in a network, the method comprising:
receiving, into a machine learning model, a value for a prediction horizon, Tw, that defines a future time interval for generating predicted data corresponding to an element in a model region;
receiving machine learning training data that includes data corresponding to previous element activity in the model region, wherein the model region comprises at least one model cluster, and wherein each of the at least one model cluster comprises a plurality of model cells that are adjacent to one another;
generating, using the machine learning model, model cell parameters that define a cell size and a cell geometry; and
generating, using the machine learning model, model cluster parameters that comprise a cluster geometry, a cluster centroid value that identifies a center of the model cluster and a cluster radius value that defines a quantity of model cells from the cluster centroid value to an edge of the model cluster.

2. The method of claim 1, wherein the model cluster parameters further comprise a cluster overlap that defines a number of model cells that are included in adjacent model clusters.

3. The method of claim 1, wherein the machine learning training data comprises:
a current position of the element in the model region;
a previous position of the element in the model region; and
a future position of the element in the model region.

4. The method of claim 1, wherein the model region is two-dimensional,
wherein the cell geometry comprises a two-dimensional shape in the model region, and
wherein the cluster geometry comprises the two-dimensional shape.

5. The method of claim 4, wherein the two-dimensional shape comprises a hexagonal shape.

6. The method of claim 1, wherein the at least one model cluster comprises a plurality of model clusters, wherein the method further comprises automatically generating the plurality of model clusters in the model region based on the model cluster parameters.

7. The method of claim 6, wherein automatically generating the plurality of model clusters in the model region is performed recursively.

8. The method of claim 6, wherein automatically generating the plurality of model clusters in the model region comprises:
identifying a single model cell of the plurality of model cells in the model region as a first centroid cell corresponding to a first model cluster of the plurality of model clusters;
assigning each of the model cells that are within the cluster radius value of the first centroid cell to be in the first model cluster;
if the model region is not covered by the plurality of model clusters, identifying a second centroid cell based on the first centroid cell, the cluster radius value and the cluster overlap; and
assigning each of the model cells that are within the cluster radius value of the second centroid cell to be in a second model cluster of the plurality of model clusters.

9. The method of claim 8, further comprising stopping generating model clusters of the plurality of clusters based on the model region being covered with model clusters.

10. The method of claim 1, further comprising removing ones of the at least one model cluster that are without transitions of elements in the machine learning training data.

11. The method of claim 1, further comprising training the at least one model cluster using a second order Markov chain model.

12. The method of claim 1, further comprising training the at least one model cluster to generate a transition matrix corresponding to each of the at least one model cluster.

13. The method of claim 1, wherein, responsive to one of the at least one model cluster including a maximum number of transitions of elements, reducing the cluster radius value corresponding to that model cluster.

14. The method of claim 12, wherein after training the at least one model cluster, performing an inference operation that is based on the transition matrix and that provides a probable future model cell that the element will be in at Tw and a confidence value corresponding the probable future model cell in response to receiving a current position of the element in the model region and a previous position of the element in the model region.

15. The method of claim 14, wherein in response to the current position and the previous position being in an overlapping area of multiple ones of the at least one model cluster, the inference operation uses weighted averages corresponding to the multiple ones of the at least one model cluster.

16. The method of claim 14, wherein the probable future model cell comprises a future position of the element in the model region.

17. The method of claim 14, wherein the probable future model cell comprises a confidence value that corresponds to the future position in the model region.

18. The method of claim 1, further comprising:
receiving updated machine learning training data that includes data corresponding to updated transitions of elements in the model region; and
updating the at least one model cluster and/or a transition matrix responsive to receiving the updated machine learning training data.

19-28. (canceled)

29. A computer program comprising program code to be executed by processing circuitry of a computing device adapted for machine learning dynamic model scope selection for a radio network, whereby execution of the program code causes the computing device to perform operations comprising:
receiving machine learning training data that includes data corresponding to previous element activity in a model region, wherein the model region comprises at least one model cluster, and wherein each of the at least one model cluster comprises a plurality of model cells that are adjacent to one another;
generating, using a machine learning model, model cell parameters that define a cell size and a cell geometry; and
generating, using the machine learning model, model cluster parameters that comprise a cluster geometry, a cluster centroid value that identifies a center of the model cluster and a cluster radius value that defines a quantity of model cells from the cluster centroid value to an edge of the model cluster.

30. (canceled)

31. A computer program product comprising a non-transitory storage medium including program code to be executed by processing circuitry of a computing device adapted for machine learning dynamic model scope selection for a radio network, whereby execution of the program code causes the computing device to perform operations comprising:
receiving machine learning training data that includes data corresponding to previous element activity in a model region, wherein the model region comprises at least one model cluster, and wherein each of the at least one model cluster comprises a plurality of model cells that are adjacent to one another;
generating, using a machine learning model, model cell parameters that define a cell size and a cell geometry; and
generating, using the machine learning model, model cluster parameters that comprise a cluster geometry, a cluster centroid value that identifies a center of the model cluster and a cluster radius value that defines a quantity of model cells from the cluster centroid value to an edge of the model cluster.

32. (canceled)
